(19) United States
(12) Patent Application Publication
(10) Pub. No.: US 2026/0064395 A1
(43) Pub. Date: Mar. 5, 2026

(54) APPLICATION REGISTRATION PROCESS WITH DIGITAL PLATFORM

(71) Applicant: Honeywell International Inc., Charlotte, NC (US)

(72) Inventors: Upender Paravastu, Bangalore (IN); Vidya Shivamurthy, Glen Allen, VA (US); Ambika Khatri, Bangalore (IN); Ritesh Jain, Bangalore (IN); Jayashree Madanala, Bagalkot (IN); Gaurav Kumar, Bangalore (IN)

(21) Appl. No.: 18/822,321

(22) Filed: Sep. 2, 2024

(51) Int. Cl. G06F 8/60

(52) U.S. Cl. CPC G06F 8/60

(57) ABSTRACT

A system for registration of a software application on a digital platform, having one or more processors, a memory storing program instructions which, when executed by the one or more processors, causes the processor to create a pipeline between the software application and the digital platform, wherein the pipeline provides an interface between the software application and the digital platform, define a template to capture one of more parameters of the software application, wherein the template is based on the pipeline created between the software application and the digital platform, capture the one or more parameters of the software application, wherein the one or more parameters are relating to one or more of indexing, packaging, versioning of the software application, define a resources requirement of the software application, wherein the resources are classified as initialization resources and deployment resources and the initialization resources are only created once at the registration of a software application, update the resources requirement by defining an order of creation of the resources, wherein the initialization resources are created prior to the creation of deployment resources and determine if the one or more parameters and the resources requirement of the software application are compatible with the digital platform and based on the determination, transmit the one or more parameters and the resources requirement of the software application to the digital platform, via the pipeline.

### TECHNICAL FIELD

Embodiments of the present disclosure generally relate to application registration with a digital platform, and specifically, to a system and method for registration of a software application with an integration framework of a digital platform to enable deployment of the software application on a cloud environment.

### BACKGROUND

Conventional software applications were originally developed for deployment on a standalone machine. Such application utilizes resources of the standalone machine and performs its desired functioning. However, due to several advantage provided by deploying applications on a digital platform, it is desirable that the applications which were originally created for use on standalone machines, are now deployed on the digital platform. The advantages include resource optimization using artificial intelligence and machine learning, cloud-based tracking, remote access etc.

Deploying of a standalone application on a digital platform can be a tedious task, requiring several portions of the software code to be re-written for being compatible with the integration framework of the digital platform and even then, the performance of the application may not be optimal on the digital platform due to lack of standardized compatibility, inefficient re-development etc. Due to lack of standardized registration with the digital platform, the software applications may still require additional coding, transformation in case a new version or update is made to the software application. This can not only delay the integration of the software application with the digital platform but also require additional steps in integration with the digital platform.

Accordingly, there is a need for providing efficient registration of an existing software application on an integration framework of the digital platform. Through applied effort, ingenuity, and innovation, the inventors have solved the above problem(s) by developing the solutions embodied in the present disclosure, the details of which are described further herein.

### BRIEF SUMMARY

In general, embodiments of the present disclosure herein provide system and method for efficient registration of a software application with an integration framework of a digital platform to enable deployment of the software application on a digital platform. Other implementations will be, or will become, apparent to one with skill in the art upon examination of the following figures and detailed description. It is intended that all such additional implementations be included within this description be within the scope of the disclosure and be protected within the scope of the following claims.

In accordance with an embodiment of the present disclosure, an exemplary system for registration of a software application on a digital platform is provided. A system comprises: one or more processors; a memory storing program instructions which, when executed by the one or more processors, causes the processor to create a pipeline between the software application and the digital platform, wherein the pipeline provides an interface between the software application and the digital platform. The system further defines a template to capture one of more parameters of the software application, wherein the template is based on the pipeline created between the software application and the digital platform. The system further captures the one or more parameters of the software application, wherein the one or more parameters are relating to one or more of indexing, packaging, versioning of the software application; defines a resources requirement of the software application, wherein the resources are classified as initialization resources and deployment resources and the initialization resources are only created once at the registration of a software application, updates the resources requirement by defining an order of creation of the resources, wherein the initialization resources are created prior to the creation of deployment resources and determines if the one or more parameters and the resources requirement of the software application are compatible with the digital platform and based on the determination, transmit the one or more parameters and the resources requirement of the software application to the digital platform, via the pipeline.

In another embodiment, the present disclosure provides a method for registration of a software application on a digital platform. method comprising creating a pipeline between a software application and a digital platform, wherein the pipeline provides an interface between the software application and the digital platform; defining, a template to capture one of more parameters of the software application, wherein the template is based on the pipeline created between the software application and the digital platform; capturing, the one or more parameters of the software application, wherein the one or more parameters are relating to one or more of indexing, packaging, versioning of the software application; defining a resources requirement of the software application, wherein the resources are classified as initialization resources and deployment resources and the initialization resources are only created once at a registration of a software application; updating the resources requirement by defining an order of creation of the resources, wherein the initialization resources are created prior to the creation of deployment resources; and determining if the one or more parameters and the resources requirement of the software application are compatible with that cloud environment and based on the determination, transmitting the one or more parameters and the resources requirement of the software application to the digital platform.

In yet another embodiment, the present disclosure provides a non-transitory computer-readable storage medium comprising computer program code for execution by one or more processors of an apparatus, the computer program code configured to, when executed by the one or more processors, cause the apparatus to create a pipeline between a software application and a digital platform, wherein the pipeline provides an interface between the software application and the digital platform; define, a template to capture one of more parameters of the software application, wherein the template is based on the pipeline created between the software application and the digital platform; capture, the one or more parameters of the software application, wherein the one or more parameters are relating to one or more of indexing, packaging, versioning of the software application; define a resources requirement of the software application, wherein the resources are classified as initialization resources and deployment resources and the initialization resources are only created once at a registration of a software application; update the resources requirement by defining an order of creation of the resources, wherein the initialization resources are created prior to the creation of deployment resources; and determine if the one or more parameters and the resources requirement of the software application are compatible with that digital platform and based on the determination, transmit the one or more parameters and the resources requirement of the software application to the digital platform, via the pipeline.

The above summary is provided merely for the purpose of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject will become apparent from the description, the drawings, and the claims.

### BRIEF DESCRIPTION OF DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates a block diagram of a system for registration of a software application with a digital platform, in accordance with an embodiment of the present invention.

FIG. 2 illustrates a block diagram of a pipeline for registration of a software application with a digital platform, in accordance with an embodiment of the present invention.

FIG. 3 illustrates a flow chart of the steps executed by a system for registration of a software application with a digital platform, in accordance with an embodiment of the present invention.

FIG. 4 illustrates a flow chart of the steps executed for registration of components of a software application, in accordance with an embodiment of the present invention.

FIG. 5 illustrates a flow chart of the steps executed for registration of resources of a software application, in accordance with an embodiment of the present invention.

FIG. 6 illustrates a user interface for registration of a software application with a digital platform, in accordance with an embodiment of the present invention.

FIG. 7 illustrates an exemplary template view for registration of a software application with a digital platform, in accordance with an embodiment of the present invention.

FIG. 8 illustrates another exemplary template view for registration of a software application with a digital platform, in accordance with an embodiment of the present invention.

FIG. 9 illustrates a block diagram of a system for registration of plurality of software applications with a digital platform, in accordance with an embodiment of the present invention.

### DETAILED DESCRIPTION

The description that follows describes, illustrates and exemplifies one or more particular embodiments of the invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the invention is intended to cover all such embodiments that may fall within the scope of the appended claims, either literally or under the doctrine of equivalents.

It should be noted that in the description and drawings, like or substantially similar elements may be labelled with the same reference numerals. However, sometimes these elements may be labelled with differing numbers, such as, for example, in cases where such labelling facilitates a clearer description. Additionally, the drawings set forth herein are not necessarily drawn to scale, and in some instances, proportions may have been exaggerated to more clearly depict certain features. Such labelling and drawing practices do not necessarily implicate an underlying substantive purpose. As stated above, the specification is intended to be taken as a whole and interpreted in accordance with the principles of the invention as taught herein and understood to one of ordinary skill in the art.

With respect to the exemplary systems, components and architecture described and illustrated herein, it should also be understood that the embodiments may be embodied by, or employed in, numerous configurations and components, including one or more systems, hardware, software, or firmware configurations or components, or any combination thereof, as understood by one of ordinary skill in the art. Accordingly, while the drawings illustrate exemplary systems including components for one or more of the embodiments contemplated herein, it should be understood that with respect to each embodiment, one or more components may not be present or necessary in the system.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

Embodiments of the present disclosure provides a system and method for efficient registration of a software application on a digital platform by utilizing an automated pipeline. In this regard, for registration of an application on the digital platform, details relating to application template are provided to the automated pipeline. The application template may be provided with details relating to App Manifest, App Key, App Version and App parameters. This template provides relevant details regarding the application to be deployed on the digital platform and initializes the automated pipeline with relevant details regarding the application. Further, for completing the registration, details relating to application resource are also defined. The resource details can be categorized into Initialization resources and Deployment resources, based on whether the resources are needed only for registration or are also needed upon deployment of the application on the cloud environment.

The pipeline provided in accordance with the present disclosure allow for continuous integration and continuous deployment (CI/CD) pipeline thus providing registration of an application while it is being developed (or upgraded). Accordingly, as per the present disclosure a user can easily setup registration of an application on the digital platform by providing the application template, application resource details, as explained above etc.

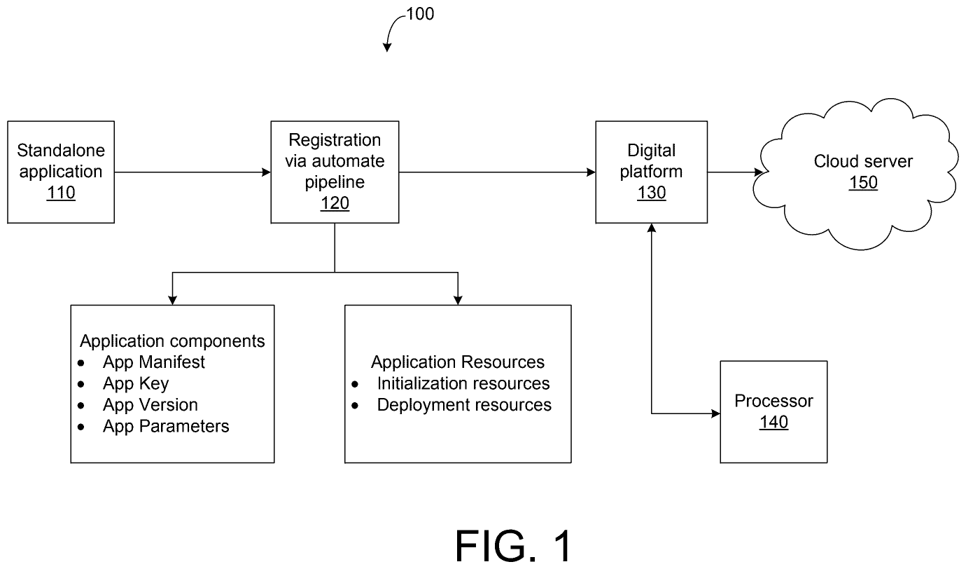

FIG. 1 provides a block diagram of a system for registration of a software application with a digital platform, in accordance with an embodiment of the present invention. A standalone application 110 is to be registered on a digital platform 130 which may enable access to cloud environment 150. To setup this registration in accordance with the present disclosure, an automated pipeline is configured for registering the application 110 to the digital platform 130. The registration via the pipeline involves providing various details of application components 121 and application resources 122. The registration involves providing the application details in a defined format. The application components 121 may require details relating to App Manifest, App Key, App Version and App parameters. The App Manifest requires basic details relating to index and packaging of the application. The App Key is the unique identifier of the application. App Version ensure proper versioning of the file as well as the versioning of the gateway to which the application is being deployed. App parameters provides details regarding the input and output parameters of the application as well as the any other variables required for the application. Further, details relating to whether such parameters are essential or not, whether such parameters have default value or not, are also provided. Still further, the default values, if any, may also be provided as App parameters.

The present disclosure provides that application resources 122 are also defined within the pipeline at registration. Said details may be provided by selecting relevant values for each resource involved or directly providing a resource file of the application covering the required data. The details regarding application resources 122 may be categorized into initialization resources and development resources. Further, the order of creation of various resources, is also determined and updated in the pipeline.

Once all the required details for application registration are provided, the automatized pipeline can then determine if the application parameters and resource requirement are compatible with the digital platform environment and can then be utilized for efficient registration and deployment of the application on the digital platform environment.

In accordance with an embodiment of the present disclosure as illustrated in FIG. 1, standalone application 110 (or software application) is to be registered on a digital platform 130 which may enable the application to be accessed on the cloud environment 150 and therefore, the resources need to running the software application can be optimized and the software application can be integrated as a package to a customer. Accordingly, it is highly desirable to that the software application 110 is integrated with the digital platform 130. However, each software application has its own unique attributes, resource requirements, parameters, versions etc, such that registration of each software application on the digital platform can be a tedious task. In accordance with the present disclosure, for registration of a software application on a digital platform, a pipeline 120 with application template is defined. The template can be pre-defined and lists the required application component 121 and application resources 122. The registration template may be defined by the authorized users of the digital platform and the template once defined can be used for registration of various software applications. Further, the template may be changed by authorized users based on evolution of the digital platform 130.

The purpose of defining a pipeline with an application template is to standardize and automate the registration of a software application on a digital platform. In conventional systems, for migration of a software application to a digital platform, re-writing of code of the software application would be needed. In this regard, for each software application to be migrated, its code must be suitable modified and if there are a large number of software applications to be migrated, significant effort would be involved in such migration due to lack of automated registration and/or defined template. Further, in case there is an upgradation or new version of the software application to be updated on the digital platform, lack of standardized registration template requires additional effort and re-programming for migration of the software application on the digital platform. Still further lack of standardized template for registration of a software application can result is inefficient utilization of resources of the digital platform.

In accordance with the present disclosure, to allow registration of a software application on a digital platform, a pipeline is created to capture details of the software application in a defined template. The defined template may include both components and resources requirements of the software application. The components of the software application include application manifestation file, App key, version of the software application, application parameter file etc. To enable a user with the registration, a readme file for populating the pipeline may also be provided to provide instructions on filling the application component and resources. In application components, manifestation file provides an index or package of the software application and defines title of various attributes and description of the software application. App key is an identifier that uniquely identifies the template. Application component also includes the version of the application and it may also include the version of gateway to which this application has been deployed. The version information may also provide tracking regarding the compatibility and future integration/deployment.

The application component further includes a parameters file of the software application at registration which provides details relating to various deployment variables, port values etc. Also, provided in the parameter file are the default value of each parameter. If any of the application component provided at this registration is missing and/or incomplete, an error will be shown to a user and the application will not proceed with the registration. In case all the application components are duly provided, the application registration process moves to the next step.

Subsequent to the application components, details regarding application resource requirements are defined. The details regarding the resources that will be required by the software application for deployment on the digital platform are provided. An index file of the resources may define the order in which each of the resources will be created at the digital platform. The resources may be classified into two main categories, initialization resources and deployment resources. The initialization resources are the prerequisite resources needed for application to be installed and are created only once. The deployment resources provide container definitions of the resources as needed upon deployment of the software application on the digital platform. In addition to the resource requirements, additional information relating to the resources like order of creations, data types etc may also be provided at the registration stage. Such information of the resources may be provided as part of the index file or may be included separately as per the template of the pipeline for registration.

As per an embodiment of the present disclosure, once all the application components and application resource requirements are provided for registration, it is determined whether the digital platform will support the software application as being registered and subsequently being deployed on the digital platform. Such determination may be based on compatibility of the application components and/or application resources. For instance, the required deployment resources may not be available with the digital platform and in such a case, the registration will not be successful. Still further, it may be determined that the format, type etc of the resource requirement are not compatible with the format of the digital platform and the registration will not be successful.

In an alternative embodiment, the determination of the compatibility of the components and resources of the application with the digital platform may not be carried at the registration stage and may be determined later. In such a case, the registration will be successful as soon as relevant application component and resources details are provided as per the template of the registration pipeline. In a still alternative embodiment, the registration and determination of compatibility may be performed simultaneously but are not dependent upon one another, i.e. upon providing of all the details, the registration may be successful but the compatibility check may not be successful. Alternatively, the compatibility check may be successful, but the registration may be unsuccessful, in case the details provided are not as per the template.

As per an embodiment of the present disclosure, the registration of an application based on the template of the pipeline may provide appropriate guidance and error handling at the registration. In this regard, as mentioned previously, the registration template may provide a readme file to guide a user with the registration process. In addition, each entry item (i.e. components and resources) may provide relevant hints, tips, insights, examples for case of user input. The hints may be provided to a user at each entry point or may direct the user to a separate page with the relevant details. Also, each entry provided by the user may be checked for error/incompatibility at each entry itself, such that subsequent entries may remain inactive unless previous errors are not fixed. Alternatively, the user may be allowed to entry all the information and then the error are checked only after the user submits the registration request. Based on the submission, the errors if any, may be shown against respective entries or may be shown in the form of a report. Such report can not only list the error but also provide guidance regarding the corrections needed to fix the errors. Still further, such reports can also be provided to system administrator of the digital platform for analysis and providing suggestions to the user facing error at the registration stage. The error report can also be used for identifying common error and a system administrator of the digital platform may accordingly update the template pipeline for providing case in future registrations of software applications. In addition, the readme file and/or the hints for each entry item may be suitably updated to further improve case of user entry.

As per an embodiment of the present disclosure, more than one software application may be registered on to the digital platform. In this regard, a single template provided may allow a user to register plurality of software applications on the digital platform. The user may input component and resources details of plurality of applications together or one after the other. The pipeline may then perform relevant checking of the provided information of the software applications and accordingly provide registration report to the user. In case there are error(s), a suitable report may be provided to the user. The report may be a single report covering all applications being registered or separate report for each registration may be provided. As per an embodiment of the present disclosure, the registration will not be competed if all errors, for each application are not addressed. In an alternative embodiment, some of the software applications will be successfully registered and others will be pending due to one or more errors. Based on the number of applications being registered, the template of the pipeline may be formed accordingly. Alternatively, multiple pipelines may be formed at the backend, one for each application, while still providing case of registration for a user for plurality of applications.

As per an embodiment of the present disclosure, the registration of an application will be done by a user on a web-form. The user will enter relevant details relating to application components and resources on the template. Once all the details are entered and user submits a request, the registration will complete and relevant details of the software application will be provided to the digital platform via the pipeline. In an alternate embodiment, the user may provide the relevant details of the software application on a file stored with the user. The registration process will involve uploading of such pre-filled file at a registration interface and the registration will proceed similar to as if user filled-in the template. Also, errors if any, may be provided to the user on the user interface directly or in a separate report.

The pipeline created to automate registration of a software application on a digital platform can be based on an existing pipeline of the digital platform or may be created particularly for the registration of software application. Further, the template of the registration may be based on the architecture and characteristics of the digital platform. The order of application components and application resources being entered may be altered considering case of user input and/or based on architecture of the digital platform. Such template may be updated at the digital platform based on upgradation of the digital platform, user feedback etc. Once or more components and resources may be clubbed together as part of the user inputs to further exchange and case the registration process.

As per an embodiment of present disclosure, based on user inputs regarding application components, the pipeline provides standardized template for key attributes of every software application being registered on the digital platform. The application components include app manifestation, App key, app version etc, which ensure that these key attributes for each application are available for each software application at the registration stage in a common format that subsequent steps of deployment on the digital platform can be standardized. Likewise, standardized template for capturing details of application resources provide for obtaining resources requirements of all software applications in a defined format. Particularly, order of creation of each resource as well as details of the initialization and deployment resources of software application provide resource requirements for every software application being registered with the digital platform.

As resource requirement of each software application is known at the registration stage, the architecture and capacity of the digital platform can be better planned and managed to provide seamless deployment of each software application. Still further, as application components and resources template for registration are standardized, the process for registration and subsequent deployment is no longer cumbersome and the authorized administrator of the digital platform can become trained with the template which further provides an efficient registration process.

As the process of registration of software application on the digital platform based on the template provides efficient and timely registration, the software applications can be deployed on the digital platform without delay. Hence, the standalone application can efficiently gain the benefits of being deployed on digital platform; such gains may include remote access, cloud storage, optimum resource utilization etc. Also, the software applications can be registered with the digital platform can be based on continuous integration, continuous development (CI/CD) pipeline with a defined template.

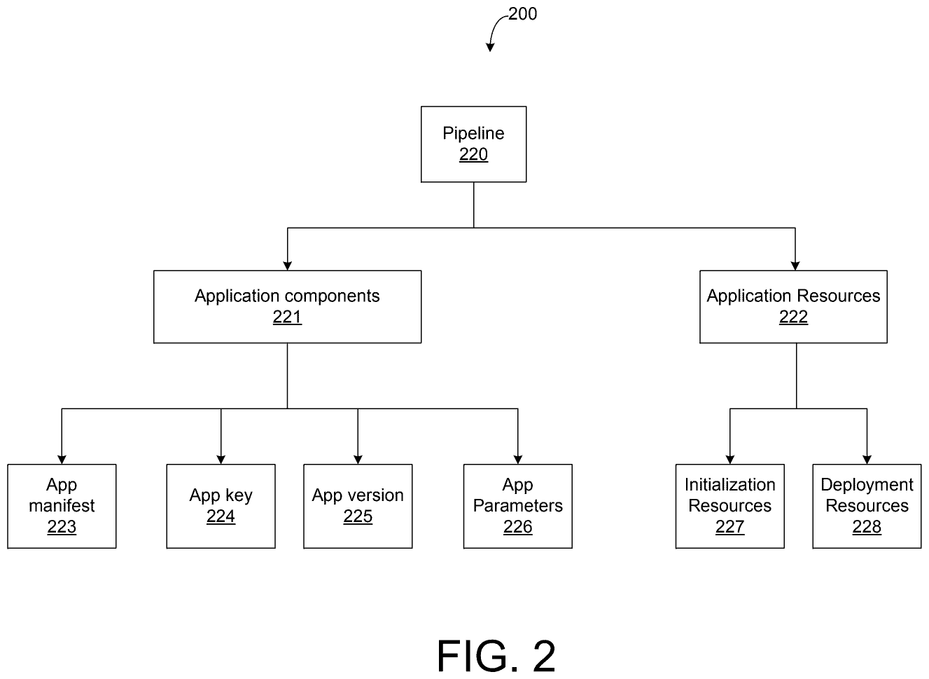

Registering of a software application on a digital platform by creating a pipeline with defined template provides standardized and efficient registration for each software application. The structure of pipeline created for the registration is illustrated on FIG. 2. As per an embodiment of the present disclosure, a pipeline 220 involves various application components 221 and application resources 222. The registration involves providing the application details in a defined format. A typical application component 221 of a pipeline 220 may require details relating to App Manifest, App Key, App Version and App parameters. The App Manifest covers details relating to index and packaging of the software application. The App Key covers details of a unique identifier of the software application. The App Version provides details relating to proper versioning of the software application. The App version ensures tracking of updates of the software application. App parameters of the application components cover details regarding the input and output parameters of the application as well as the any other variables required for the software application. The App parameters may also include details of essentiality of various parameters, their default value, their characteristics etc. Combinedly, details regarding the application index, versions, parameters provide relevant details regarding the software application for standardized registration on a digital platform.

The pipeline also includes details regarding application resources. The application resources details may be provided by selecting relevant values for each resource regarding for working of the software application. The application resources may be classified as initialization resources and development resources. Further details regarding the order of creation of various resources, may also be provided while registration via the pipeline.

In accordance with an embodiment of the present disclosure as illustrated in FIG. 2, for registration of a software application on a digital platform, a pipeline 220 with application template is defined. The template can be pre-defined and lists the required application component 221 and application resources 222. The registration template may be defined by an authorized user of the digital platform and the template once defined can be used for registration of various software applications. Further, the template may be changed by an authorized user based on evolution of the digital platform and/or technology in general. A pipeline providing an application template, allows to standardize and automate the registration of a software application on a digital platform. In prior art systems, migration of a software application to a digital platform required re-writing of code of the software application and there was no standardization. Particularly, code of each software application must be suitable modified and there was no control of the application parameter and resources requirement as such details may not be captured in the prior art system. Still further, lack of standardized registration template requires additional effort and re-programming for migration of the software application on the digital platform; and involved no versioning control. Also, lack of standardized template for registration in the prior art system may lead to inefficient utilization of resources of the digital platform.

In accordance with the present disclosure, a pipeline is created to capture details of the software application in a defined template, to allow its registration on a digital platform. The defined template may include both components and resources requirements of the software application. The components of the software application includes application manifestation file, App key, version of the software application, application parameter file etc. For registration via the pipeline, a readme file for user guidance may be provided. The fields captured by the application component are now described. Application manifestation file provides an index or package of the software application and defines title of various attributes and description of the software application. App key is an identifier to uniquely identify the template. Application component may further include the version of the software application, in addition to version of gateway to which the software application has been deployed. The application component further includes details of the parameters of the software application at registration as well as includes default value of each parameter.

In case any application component provided at this registration stage is missing, an error may be shown to a user and the application will not proceed with the registration. If all the application components are correctly provided, the application registration process moves to capturing the application resources. The application resources provide details required by the software application for deployment on the digital platform. In this regard, an index file may define the order in which each of the resource will be created at the digital platform. The resources may be initialization resources and deployment resources. The initialization resources are the prerequisite resources needed for a software application to begin and are created once at the inception. The deployment resources provide container definitions of the resources as needed upon deployment of the software application on the digital platform. Additional information relating to the resources like order of creations, data types etc may also be provided via the pipeline at registration.

As per an embodiment of the present disclosure, the pipeline created for registration of the software application on the digital platform also involves determination whether the digital platform will support the software application based on the application components and resources provided. Particularly, such determination may be based on compatibility of the application components and/or application resources. In this regard, the required application resources may not be available with the digital platform and therefore, the registration will not be successful. Also, if it is be determined that the format, data type etc of the resource requirement are not compatible with that of the digital platform, then the registration will not be successful. While the determination of compatibility has been incorporated within the pipeline, in an alternative embodiment, such determination of the compatibility of the components and resources of the software application with the digital platform may be performed prior to the registration. Still alternatively, such determination may be performed after the registration at the end of the digital platform and is not carried within the pipeline. In such a case, the registration will be successful as soon as relevant application component and resources details are provided, as per the template of the registration pipeline. Further, even if the compatibility is determined at the registration stage, it is may not impact the registration, such that the registration may be successful but the compatibility check may not be successful or vice-versa.

The user interface for registration via the pipeline template may provide a readme file to guide a user. In addition, each entry item (i.e. components and resources) may provide relevant hints, tips, insights, examples for ease of user entry. The user may be allowed to entry all the information and then the error are checked only after the user submits the registration request. Alternatively, each entry may be checked for incompatibility at each entry itself, such that subsequent entries are made inactive unless previous errors are not fixed. Errors, if any, may be shown against respective entries or may be shown in the form of a message or a report. The report may provide guidance of the corrections needed to fix the errors. The report can also be used for identifying common error and the system administrator of the digital platform may accordingly update the template pipeline for providing case in future registrations.

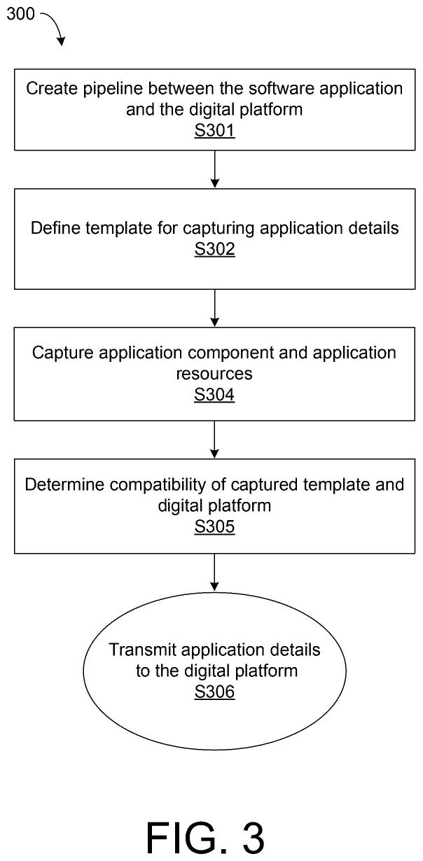

The template created for registration of the software application provides standardized correction of details for the software application. It involves, capturing of components and resources requirements of a software application in a standardized manner and comparing the compatibility of components/resources of the software application with that of the digital platform. The steps for registration in accordance with the present invention have been provided in FIG. 3. Firstly, at step S301, a pipeline is created between the software application and digital platform. The pipeline acts as an interface for providing the details of the software application to the digital platform in a standardized manner. The pipeline created then needs to define a template for capturing application details in a standardized manner. The template may be defined by the administrators of the digital platform to capture required details of a software application. In an alternative embodiment, the template may be defined by the separate team, which is providing support for the migration of the software application to the digital platform. In still an alternative embodiment, the template may be pre-defined centrally and is automatically updated based on upgradations of the digital platform.

Thereupon, the template for capturing details of the software application for registration on the digital platform are defined at step S302. The template defines the complements, parameters, resources requirements, particulars of creation of resources etc of a software application. The template not only lists the fields to be captured, but also specifies the order in which the registration form asks for the required details. The purpose of defining a template is to standardize and automate the registration of a software application on a digital platform. The defined template includes both components and resources requirements of the software application. The defined template may be modified by an authorized user at the digital platform. The template provided may also include appropriate guidance and error handling at the registration for a user. As mentioned previously, each entry item (i.e. components and resources) may provide relevant hints, tips, insights, examples for case of user entry. The hints may be provided to a user at each entry point or may direct the user to a separate page with the relevant details. Also, the registration template may provide a readme file to guide a user with the registration process. Further, each entry provided by the user may be checked for error, such that subsequent entries are made inactive unless previous errors are not fixed. Alternatively, the user may be allowed to enter all the information and then the error are checked only after the user submits the registration request. In case there is an update to the template, the readme file and/or the hints for each entry item may be suitably updated.

Next, once the template for capturing application details have been defined, the details of the software application are captured at step S304. This step involves capturing application component and application resources. The components of the software application may include application manifestation file, App key, version of the software application, application parameter file. Again, a readme file for populating the pipeline may also be provided for case of a user. The application component's manifestation file provides an index or package of the software application and defines title of various attributes and description of the software application. App key allows to uniquely identify the software application in a given template. Application component further include details relating to the version of the application. The version information also provides tracking regarding the compatibility and future integration/deployment. The application component may further include a parameters file of the software application at registration which provides details relating to various deployment variables, port values, connections etc. Also, any default value of each parameter may be provided. If any of the application component provided at this registration is missing and/or incomplete, an error prompt may be shown to a user and the application will not proceed with the registration.

Thereupon, details regarding resource requirement of the software application is provided. It covers the details of the resources that will be required by the software application for deployment on the digital platform. The resources may be classified into two main categories, initialization resources and deployment resources. The initialization resources are the prerequisite resources needed for application to work and are created only once. The deployment resources provide container definitions of the resources as needed upon deployment of the software application on the digital platform. In additional to the details of the resources, additional information relating to the resources like order of creations, data types etc may also be provided at the registration stage. An index file of the resources may define the order in which each of the resource will be created at the digital platform. Such information of the resources may be provided as part of the index file or may be included separately as per the template of the pipeline for registration.

Thereupon, once all the application components and application resources are provided for registration, it is determined whether the digital platform will support the application as being registered on the digital platform, at step S305. Such determination may be based on compatibility of the application components, application resources or both. If the required deployment resources are not be available with the digital platform, the registration will not be successful. Likewise, it may be determined that the format, type etc of the resource requirement are not compatible with the format of the digital platform and in such a case, the registration will not be successful. In this regard, the determination of the compatibility of the components and resources of the application with the digital platform may not be carried at the registration stage and may be carried out later. In such a case, the registration will be successful as soon as relevant application component and resources details are provided as per the template of the registration pipeline. Still further, the registration and determination of compatibility may be performed at the registration stage but may still be independent of one another. In a scenario, the compatibility check may be successful and the registration may be unsuccessful if the details are not provided as per the template.

Thereupon, once it is determined that all the application component and application resources have been duly provided at the registration and the same are compatible with the digital platform, the registration is completed and the application details are then transmitted to the digital platform for further deployment at step S306. The transmission of application details via the pipeline to the digital platform may be direct or it may be sent for further review. Such further review may be performed by an administrator of the digital platform before authorizing deployment of the software application on the digital platform.

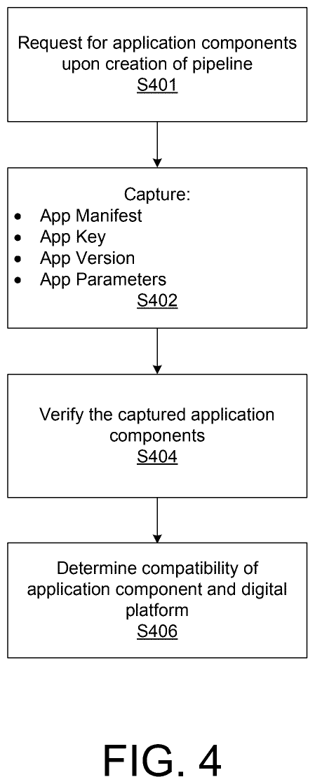

For a software application being registered on a digital platform in accordance with an embodiment of the present disclosure, the inputs providing details of the software application are mainly application components and application resources. The steps for registration of application components in accordance with the present invention have been provided in FIG. 4. At step S401, once a pipeline is created and a template is defined, the registration form requires for application component details. Said details may be asked as inputs from a user on a webform or may be fetched based on a pre-filled user file with relevant details.

At step S402, the registration form captures details of the application components. An application component of a pipeline may require details relating to App Manifest, App Key, App Version and App parameters. The App Manifest covers details relating to index and packaging of the software application. The App Key covers details of a unique identifier of the software application. The App Version includes details relating to proper versioning of the software application. The App version provides tracking of updates of a software application. App parameters of the application components cover details relating to regarding the input and output parameters of the application. The App parameters may include details of essentiality of various parameters, their default value, their characteristics etc. Accordingly, details regarding the application index, versions, parameters provide relevant details regarding the software application for standardized registration on a digital platform. Said inputs may be provided directly by a user by filling a webform or may be fetched automatically from a pre-filled directory of software application.

Thereupon at step S404, it is verified whether the application component details provided is as per the template. If any of the application component provided at this registration is missing and/or are incomplete, an error will be shown to a user and the application will not proceed with the registration. In this regard, a readme file to guide a user with the registration of application components may be provided. In addition, each components entry item may provide relevant hints, tips, insights, examples for ease of user entry. Each entry provided by the user may be checked for error/incompatibility at each entry itself, such that subsequent entries are made inactive unless previous errors are not fixed. Alternatively, the user may be allowed to enter all the information and then the error are checked only after the user submits the registration request. Based on the submission, the errors if any, may be shown against respective entries or may be shown in the form of a report. Such report can not only list the error but also provide guidance of the corrections needed to fix the errors.

Thereupon at step S405, it is determined whether digital platform will support the application components as being registered. This determination is to ensure compatibility of the application components with the digital platform. If it is determined that the format, type etc of the component are not compatible with the format of the digital platform and/or are incomplete, the registration will not be successful. This determination can be carried by the pipeline or by the digital platform itself. Further, this verification may be performed by an administrator of the digital platform and the administrator may even update the user inputs provided at the registration step. A report for this verification step may be provided to a user, or to an administrator or to both. Based on this report, a user may update the previously filled details regarding the application components.

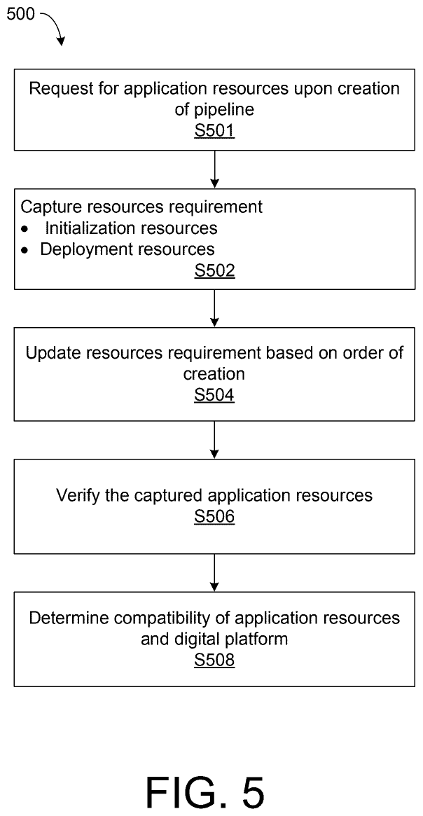

As per an embodiment of the present disclosure, details of resource requirement of a software application are also provided at the registration. The steps for registration of application resources in accordance with the present invention have been provided in FIG. 5. At step S501, once a pipeline is created and a template is defined, the registration form requires for application resources details. Such details may be input after application component details. The resource details may be asked as inputs from a user on a webform or may be fetched based on a pre-filled user file with relevant details.

At step S502, the registration form captures details of the application resources. The details provide the resources that will be required by the software application for deployment on the digital platform. The resources may be initialization resources and deployment resources. The initialization resources are the pre-requisite resources needed for application to work and are created only once at the inception. The deployment resources provide container definitions of the resources as needed upon deployment of the software application on the digital platform. Particularly, the deployment resources may provide container definitions and supporting application resources like K8S template resources. Further, information relating to the resources like order of creations may also be provided at this step. Information regarding the application resources may be provided as part of the index file or may be included separately as per the template of the pipeline for registration.

Thereupon at step S504, for the initialization resources and deployment resources, an index file providing the order in which each of the resource will be created may be provided. Such details of the order of creation may be provided directly in an index file or may be derived separately based on the details provided for various resources. In another embodiment, such details may be provided before the resources' requirement is captured at step S502.

Thereupon at step S506, it is verified whether the application resources details provided are as per the template. If any of the application resources details provided at this registration is missing and/or are incomplete, an error will be shown to a user and the application will not proceed further with the registration. In this regard, a readme file to guide a user with the registration of application resources may be provided. In addition, each application resource entry item may provide relevant hints, tips, insights, examples for case of user entry. Each entry provided by the user may be checked for error/incompatibility at each entry itself, such that subsequent entries are made inactive unless previous errors are not fixed. Alternatively, the user may be allowed to entry all the information and then the error are checked only after the user submits the registration request. Based on the submission, errors if any, may be shown against respective entries or may be shown in the form of a report.

Thereupon at step S508, it is determined whether digital platform will support the application resources as being registered. This determination is to ensure that required application resources are compatible and available with the digital platform. If it is determined that storage capacity required for application resources are not available with the digital platform and/or are incompatible, the registration will not be successful. This determination can be carried by the pipeline or by the digital platform itself. Further, this verification may be performed by an administrator of the digital platform and the administrator may even update the user inputs provided at the registration step. Also, a report for this verification step may be provided to a user, or to an administrator or to both. Based on this report, a user may update the previously filled details regarding the application resources or may submit a fresh request.

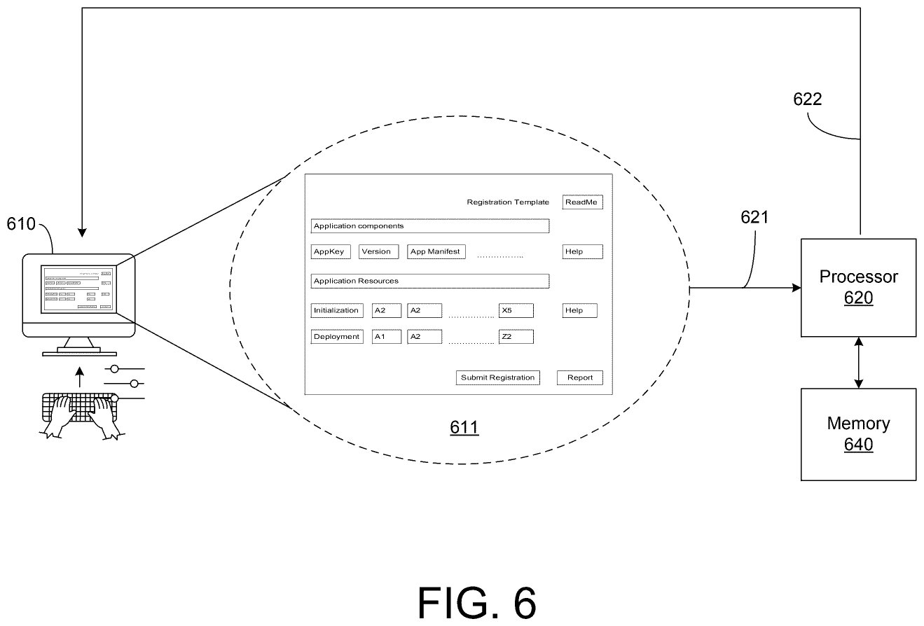

The registration of a software application may be performed based on inputs provided by the user to the system. The input may be provided to the system at a user device. The user device may be any computing device such as a laptop, computer, mobile phone etc. The user device acts as an interface of the system for receiving the input from the user. The input from the user may include application component details, resources details, index files etc. In one embodiment, the instructions may be provided in the form of options selected from a plurality of drop-down lists, check boxes etc. FIG. 6 illustrates a user interface for registration of a software application with a digital platform, in accordance with an embodiment of the present invention.

The information collected from the user may include details regarding the software application, including any remarks, references, stage of development etc. For instance, a user may only input basic details of the software application and remaining details regarding its components and resource requirements are automatically fetched from a stored library. Alternatively, the registration may be an iterative form wherein each user input updates the requests for future inputs. Also, the inputs required from the user may be customized by the administrator of the digital platform. The user may access his user interface 611 and the instructions provided by the user are provided as input 621 to the pipeline created for registration. The user input is provided to a processor 620 which is connected to a memory 640. The processor 620 may be a part of the pipeline and/or the digital platform. Alternatively, processor 620 may be a separately installed machine. Based on the user inputs sent to the processor 620, the user interface may be updated based on instructions 622 received from the processor 620 based on instructions stored in a memory 640, thus providing an iterative user input form. In an embodiment, context or data regarding customizations and method adopted therein may be stored within the memory of the processor, and may be referred to for providing interactive user interface. Processor 620 may be embodied in a number of different ways. In various embodiments, the use of the terms “processor” should be understood to include a single core processor, a multi-core processor, multiple processors and/or one or more remote or “cloud” processor(s). In some example embodiments, processor may include one or more processing devices configured to perform independently. In some embodiments, the processor 620 includes hardware, software, firmware, and/or a combination thereof that performs one or more operations described herein. The processor 620 may be configured to execute instructions stored in the memory 640 or otherwise accessible to the processor. Alternatively, the processor 620 may be configured to execute hard-coded functionality. As such, whether configured by hardware or software methods, or by a combination thereof, processor 620 may represent an entity (e.g., physically embodied in circuitry) capable of performing operations according to embodiments of the present disclosure while configured accordingly. Alternatively, the processor 620 may be embodied as an executor of software instructions, and the instructions may specifically configure the processor 620 to perform the various algorithms embodied in one or more operations described herein when such instructions are executed. In some embodiments, the processor 620 includes hardware, software, firmware, and/or a combination thereof that performs one or more operations described herein. In some embodiments, the processor 620 (and/or co-processor or any other processing circuitry assisting or otherwise associated with the processor) is/are in communication with the memory 640 via a bus for passing information. Memory 640 may be non-transitory and may include, for example, one or more volatile and/or non-volatile memories. In some embodiments, the memory 640 includes or embodies an electronic storage device (e.g., a computer readable storage medium). In some embodiments, the memory 640 is configured to store information, data, content, applications, instructions, or the like, for enabling processor 620 to carry out various operations and/or functions in accordance with example embodiments of the present disclosure.

Specific input instructions provided by a user for registration of a software application may also be based on use of specific input tools or methods. The input/output unit 610 may be in communication with the processor 620. The input/output unit 610 may comprise one or more user interface(s). In some embodiments, a user interface may include a display that comprises the interface(s) rendered as a web user interface, an application user interface, a user device, a backend system, or the like. In some embodiments, the input/output unit 610 also includes a keyboard, a mouse, a joystick, a touch screen, touch areas, soft keys a microphone, a speaker, or other input/output mechanisms. The processor 620 and/or input/output unit 610 comprising the processor may be configured to control one or more operations and/or functions of one or more user interface elements through computer program instructions (e.g., software and/or firmware) stored on a memory accessible to the processor (e.g., memory 640, and/or the like). In some embodiments, the input/output unit 610 includes or utilizes a user-facing application to provide input/output functionality.

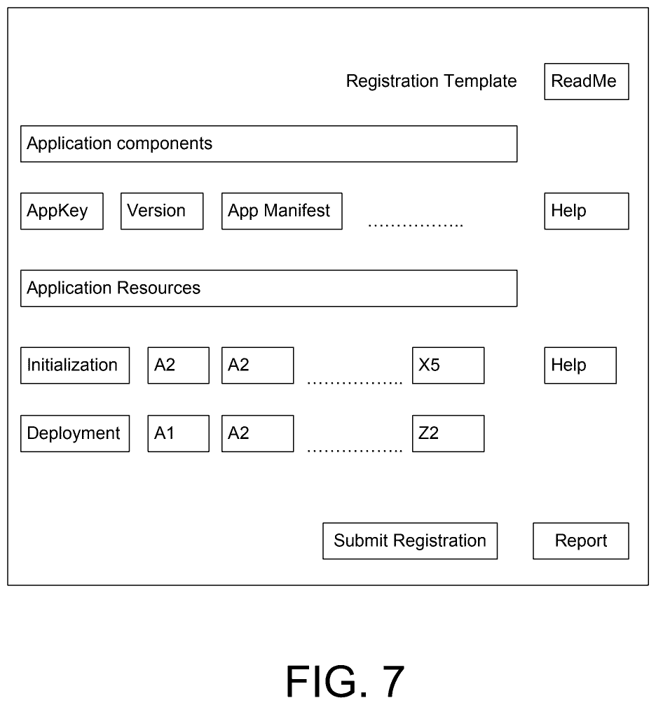

FIG. 7 provides a template for registration of a software application in accordance with the present disclosure. As shown in FIG. 7, for registration of a software application on a digital platform, plurality of inputs from a user regarding to the software application may be required. The inputs may include name, values, data type, size etc of various application components and resources. As per user interface of FIG. 7, various inputs are sequentially entered by the user to provide registration of the software application. The user interface may be made interactive such that based on each user input, subsequent inputs may be changed and/or are activated. Also, a readme file may be provided for helping the user with the registration. Such readme file may be updated by a system administrator of the digital platform. In addition, hints, suggestions, examples may also be provided to further case user entry. Alternatively, the registration form provided to the user may be basic input fields with no checks or suggestions. In such a case, only upon receiving all user inputs and after the user submits the form, checks and validations on various inputs are performed. The result of the registration request may be provided to the user in the form of a report, listing the errors, if any. Alternatively, the results may be directly displayed to a user on the input screen itself. If any of the application details provided at this registration is missing and/or incomplete, an error will be shown to the user and the application will not proceed with the registration. In case all the application components are duly provided, the application registration process moves on to next step.

As next step, it is determined whether the digital platform will support the application as being registered on the digital platform. Once the user submits the registration request, it will be determined if the required deployment resources are available with the digital platform. Based on this it is determined whether the registration will successful or not. It may be determined that the format, type etc of the resource requirement are not compatible with the format of the digital platform. In an alternative embodiment, the determination of the compatibility of the components and resources of the application with the digital platform may not be carried at the registration stage and may be determined later. The result of the registration may be displayed on the user interface or may be provided separately in the form of a report.

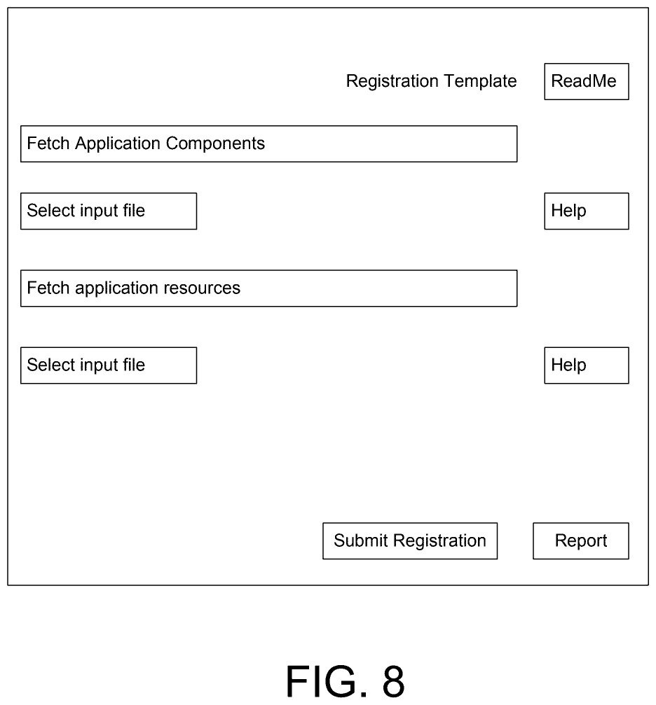

FIG. 8 provides another template for registration of a software application in accordance with the present disclosure. As per this embodiment, instead of entering plurality of details of the software application for registration on the digital platform, the user inputs pre-stored one or more files providing details of components and resources requirements of the software application. As per this embodiment, similar to the embodiment wherein plurality of inputs are taken from the user, a readme file may be provided for helping the user with the registration. Such readme file may be updated by a system administrator of the digital platform and may be different from the embodiment wherein plurality of inputs is taken from the user. Further, similar to embodiment wherein plurality of inputs is taken from the user, in the present embodiment hints, suggestions, examples may be provided. Upon receiving all user inputs and after user submits the form, checks and validations on these inputs are performed. The result of the registration request may be provided to the user in the form of a report, listing the errors if any. Alternatively, the results may be directly displayed to a user on the input screen itself. If any of the application details provided at this registration is missing and/or incomplete, an error may be shown to the user. Once the user submits the registration request, it will be determined if the required deployment resources are available with the digital platform. Based on this it is determined whether the registration will successful or not. In an alternative embodiment, the determination of the compatibility of the components and resources of the application with the digital platform may not be carried at the registration stage and may be determined later.

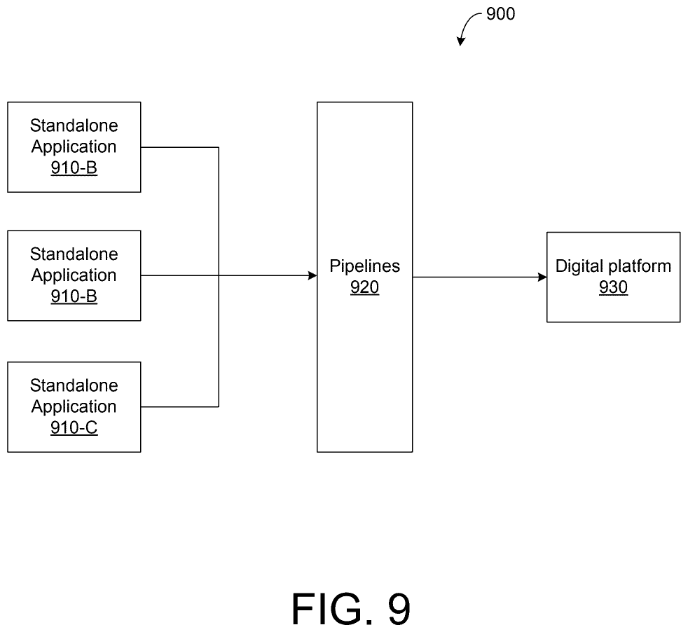

FIG. 9 illustrates block diagram for registering plurality of software application on a digital platform using one or more pipeline. In this regard, a single template provided may provide an opportunity to register plurality of software applications on the digital platform. The use may input components and resources details of plurality of software applications together or sequentially. The one or more pipelines may then provide relevant interface for registration, check the information provided for registration of the software applications and accordingly provide registration report to the user. In case there are error(s), a report may be provided such that, a single report covering all applications being registered is provided. Alternatively, a separate report for each application being registered may be provided. As per an embodiment of the present disclosure, the registration will not be competed till all errors, for each application, are not addressed. Accordingly, as per the present embodiment, the registration for plurality of software applications may be performed as a single interface for a user. In an alternative embodiment, some of the application will have successfully registered and others will be pending due to one or more errors. Further, as plurality of software applications are being registered together, the present system may be configured to allow registration of maximum number of applications, in case registration of all applications is not feasible due to lack of resources at the digital platform. Alternatively, the user may assign priority to the plurality of applications being registered and based on the priority one or more software applications may be registered. Based on the number of applications being registered, one or more pipeline may be formed accordingly. Alternatively, multiple pipelines may be formed at the backend, one for each application.

The figures of the disclosure are provided to illustrate some examples of the invention described. The figures are not to limit the scope of the depicted embodiments or the appended claims. Aspects of the disclosure are described herein with reference to the invention to example embodiments for illustration. It should be understood that specific details, relationships, and method are set forth to provide a full understanding of the example embodiments. One of ordinary skill in the art recognize the example embodiments can be practiced without one or more specific details and/or with other methods.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Aspects of the present disclosure may be implemented as computer program products that comprise articles of manufacture. Such computer program products may include one or more software components including, for example, applications, software objects, methods, data structure, and/or the like. In some embodiments, a software component may be stored on one or more non-transitory computer-readable media, which computer program product may comprise the computer-readable media with software component, comprising computer executable instructions, included thereon. The various control and operational systems described herein may incorporate one or more of such computer program products and/or software components for causing the various conveyors and components thereof to operate in accordance with the functionalities described herein.

A software component may be coded in any of a variety of programming languages. An illustrative programming language may be a lower-level programming language such as an assembly language associated with a particular hardware architecture and/or operating system platform/system. Other example of programming languages included, but are not limited to, a macro language, a shell or command language, a job control language, a script language, a database query, or search language, and/or report writing language. In one or more example embodiments, a software component comprising instructions in one of the foregoing examples of programming languages may be executed directly by an operating system or other software component without having to be first transformed into another form. A software component may be stored as a file or other data storage methods. Software components of a similar type or functionally related may be stored together such as, for example, in a particular directory, folder, or repository. Software components may be static (e.g., pre-established, or fixed) or dynamic (e.g., created or modified at the time of execution).

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

1. A system for registration of a software application on a digital platform, comprising:
a processor;
a memory; and
one or more programs stored in the memory, the one or more programs comprising instructions configured to:
create a pipeline between the software application and the digital platform, wherein the pipeline provides an interface between the software application and the digital platform;
define a template to capture one of more parameters of the software application, wherein the template is based on the pipeline created between the software application and the digital platform;
capture the one or more parameters of the software application, wherein the one or more parameters are relating to one or more of indexing, packaging, versioning of the software application;
define a resources requirement of the software application, wherein the resources are classified as initialization resources and deployment resources and the initialization resources are only created once at the registration of the software application;
update the resources requirement by defining an order of creation of the resources, wherein the initialization resources are created prior to the creation of deployment resources; and
determine if the one or more parameters and the resources requirement of the software application are compatible with the digital platform and based on the determination, transmit the one or more parameters and the resources requirement of the software application to the digital platform, via the pipeline.

2. The system of claim 1, wherein the instructions are further configured to define if the one or more parameters of the software application are mandatory.

3. The system of claim 1, wherein the pipeline is enabled with a readme file to assist in registration of the software application.

4. The system of claim 1, wherein the indexing related parameters define name and description of the software application.

5. The system of claim 1, wherein the resources requirement of the software application determines clusters and containers to be created on the digital platform.

6. The system of claim 1, wherein the pipeline enables continuous integration and continuous development of the software application on the digital platform.

7. The system of claim 6, wherein the software application is in a development stage.

8. The system of claim 1, wherein the one or more parameters of the software application are manually entered into the pipeline.

9. The system of claim 1, wherein the resources requirement of the software application is automatically fetched by the pipeline.

10. The system of claim 1, wherein based on the determination that the one or more parameters and the resources requirement of the software application are not compatible with the digital platform, an error report is provided to a user.

11. A method comprising:
creating a pipeline between a software application and a digital platform, wherein the pipeline provides an interface between the software application and the digital platform;
defining a template to capture one of more parameters of the software application, wherein the template is based on the pipeline created between the software application and the digital platform;
capturing the one or more parameters of the software application, wherein the one or more parameters are relating to one or more of indexing, packaging, versioning of the software application;
defining a resources requirement of the software application, wherein the resources are classified as initialization resources and deployment resources and the initialization resources are only created once at registration of a software application;
updating the resources requirement by defining an order of creation of the resources, wherein the initialization resources are created prior to the creation of deployment resources; and
determining if the one or more parameters and the resources requirement of the software application are compatible with the digital platform and based on the determination, transmitting the one or more parameters and the resources requirement of the software application to the digital platform.

12. The method of claim 11, further comprising defining if the one or more parameters of the software application are mandatory.

13. The method of claim 11, wherein the pipeline is enabled with a readme file to assist in registration of the software application.

14. The method of claim 11, wherein the indexing related parameters define name and description of the software application.

15. The method of claim 11, wherein the resources requirement of the software application determines clusters and containers to be created on the digital platform.

16. The method of claim 11, wherein the pipeline enables continuous integration and continuous development of the software application on the digital platform.

17. The method of claim 16, wherein the software application is in a development stage.

18. The method of claim 11, wherein the one or more parameters of the software application are manually entered into the pipeline.

19. The method of claim 11, wherein the resources requirement of the software application is automatically fetched by the pipeline.

20. A non-transitory computer-readable storage medium comprising computer program code for execution by one or more processors of an apparatus, the computer program code configured to, when executed by the one or more processors, cause the apparatus to:
create a pipeline between a software application and a digital platform, wherein the pipeline provides an interface between the software application and the digital platform;
define a template to capture one of more parameters of the software application, wherein the template is based on the pipeline created between the software application and the digital platform;
capture the one or more parameters of the software application, wherein the one or more parameters are relating to one or more of indexing, packaging, versioning of the software application;
define a resources requirement of the software application, wherein the resources are classified as initialization resources and deployment resources and the initialization resources are only created once at registration of a software application;
update the resources requirement by defining an order of creation of the resources, wherein the initialization resources are created prior to the creation of deployment resources; and
determine if the one or more parameters and the resources requirement of the software application are compatible with that digital platform and based on the determination, transmit the one or more parameters and the resources requirement of the software application to the digital platform, via the pipeline.
